(19) United States
(12) Patent Application Publication
(10) Pub. No.: US 2007/0024982 A1
(43) Pub. Date: Feb. 1, 2007

(54) IMAGING SYSTEM FOR A MICROLITHOGRAPHIC PROJECTION EXPOSURE SYSTEM

(75) Inventors: Franz Josef Stickel, Aalen (DE); Thure Boehm, Aalen (DE); Christoph Zaczek, Heubach (DE)

Correspondence Address: DARBY & DARBY P.C., P. O. BOX 5257, NEW YORK, NY, 10150-5257, US

(73) Assignee: Carl Zeiss SMT AG, Oberkochen (DE)

(21) Appl. No.: 11/423,820

(22) Filed: Jun. 13, 2006

Related U.S. Application Data
(60) Provisional application No. 60/690,739, filed on Jun. 14, 2005.

(51) Int. Cl. G02B 3/00

(52) U.S. Cl. 359/649

(57) ABSTRACT

The invention relates to an imaging system of a microlithographic projection exposure apparatus, proposing improvements in the protection of exterior optical surfaces against contamination. In an imaging system with a projection objective that serves to project an image of a mask which can be set in position in an object plane onto a light-sensitive coating that can be set in position in an image plane, a membrane which is substantially transparent for an operating wavelength of the projection objective is arranged in such a way in relation to an exterior optical surface of the projection objective that between said optical surface and the membrane an interstitial space is formed which is designed to receive a liquid or gaseous medium.

### BACKGROUND OF THE INVENTION

1. Field of the Invention

The invention relates to an imaging system, in particular a projection objective of a microlithographic projection exposure apparatus. The invention relates specifically to an imaging system in which the protection of exterior surfaces against contamination is improved.

2. State of the Art

Microlithography is used for the manufacture of micro-structured components such as for example integrated circuits or liquid crystal displays. The microlithography process is performed in a so-called projection exposure apparatus which includes an illumination system and a projection objective. In this process, the image of a mask (also referred to as a reticle) which is illuminated by means of the illumination system is projected by means of the projection objective onto a substrate (for example a silicon wafer) which is coated with a light-sensitive coating (also called photoresist) and is arranged in the image plane of the projection objective, whereby the mask structure is transferred to the light-sensitive coating of the substrate.

The problem which can occur here is that exterior optical surfaces of the projection objective which are not part of the gas-purge circuit that is normally present in the interior of the objective become contaminated from contact with the ambient atmosphere. The contaminants include in particular deposits of released salt (for example magnesium sulfate) on the exterior optical surfaces which occur especially at the short wavelengths (which are currently used with preference in order to achieve a high resolution) of, e.g., less than 250 nm and which are due to photochemical reactions that occur under the UV light being used between the ambient atmosphere (in particular S0₂ and H₂O) and the components of the anti-reflective coatings (for example MgF₂) that are normally present on the exterior optical surfaces. As the salt deposits grow, the level of stray light increases and with it the deterioration of the image quality. At the particular point where this deterioration exceeds an acceptable level, it will be necessary to clean the exterior optical surfaces, which on the one hand involves an undesirable interruption of the production process and on the other hand also the risk of further damage to the coating.

The measures taken to protect exterior optical surfaces include for example the installation of so-called purge hoods which channel a laminar gas flow of filtered and conditioned air over the exterior optical surfaces. However, in order to avoid a negative effect on the image quality, the convective flow patterns that occur with this measure need to be taken into account in the optical design, which is costly and complex. Added to this is the problem that the protective effect that can be achieved with the purge hoods is limited and that particularly when the gas flow is interrupted (either unintentionally or intentionally, e.g. for maintenance work), the now unprotected exterior optical surfaces are momentarily exposed to contact with the ambient atmosphere of the projection exposure apparatus.

Also known in the existing state of the art is the measure of vapor-depositing on the anti-reflective coatings of the exterior optical surfaces an additional layered structure (so-called top coatings), which consist typically of a sequence of several SiO₂ layers which are less susceptible to the formation of salts.

In immersion objectives which are used to obtain ever higher numerical aperture values, an interstitial space between the image plane and the last optical element towards the image plane is filled with an immersion medium (for example de-ionized water) which has a refractive index greater than 1. This can lead to the problem that substances released from the light-sensitive coating can get through the immersion liquid onto the image-side exterior surface of the last optical element. An unwanted chemical change of this exterior surface can further occur as a result of a reaction between the material of the exterior optical surface and the immersion liquid itself, for example if the de-ionized water dissolves CaF₂ ions out of a CaF₂ lens that stands in the last position on the image side.

### SUMMARY OF THE INVENTION

The present invention has the objective to provide an imaging system which has improved protection of exterior optical surfaces against contamination.

A solution that meets this objective is described by the features of the independent patent claims.

According to the invention, an imaging system of a microlithographic projection exposure apparatus has a projection objective that serves to project an image of a mask which can be set in position in an object plane onto a light-sensitive coating that can be set in position in an image plane, and it further has at least one membrane which is substantially transparent for an operating wavelength of the projection objective and which in relation to an exterior optical surface of the projection objective is arranged in such a way that between the optical surface and the membrane a space is formed which is designed to receive a liquid or gaseous medium.

The term “exterior optical surface” in the context of the present patent application means the object-plane-facing surface of the first optical element of the projection objective or the image-plane-facing surface of the last optical element of the projection objective.

The arrangement according to the invention is effective in preventing the thus protected exterior optical surface of the projection objective from coming into contact with the ambient atmosphere, so that the risk of contamination of this optical surface through the formation of salt or by other deposits is averted, because in accordance with the invention a defined atmosphere with specified properties, i.e. of a specified chemical composition, can be established in the interstitial space, independent of the ambient environment of the projection objective.

According to a preferred embodiment, the medium includes a purge gas which is substantially chemically inert, in particular nitrogen (N₂), argon (Ar), helium (He), or mixtures thereof.

According to a preferred embodiment, the interstitial space is connected to a purge circuit which serves to flush an interior space of the projection objective with the purge gas.

In one embodiment, the interstitial space is substantially sealable against the ambient atmosphere of the projection objective.

In one embodiment, a substantially tubular shaped element which surrounds the interstitial space is arranged between the exterior optical surface and the membrane. Thus, the tubular-shaped element forms a wall for the interstitial space, surrounding the latter together with the exterior optical surface and the membrane. The tubular-shaped element can be cylindrical or have any other desired geometry that is suitable (for example a rectangular cross-section).

In one embodiment, the membrane is arranged between the image plane and a last optical element of the projection objective on the side towards the image plane. In another embodiment, the membrane is arranged between the object plane and a first optical element of the projection objective on the side towards the object plane.

According to a preferred embodiment, the membrane has a transmissivity of at least 75%, preferably at least 85%, and with even higher preference at least 95% for the operating wavelength of the projection objective.

According to a preferred embodiment, the membrane is made of a material which has an index of refraction of less than 1.6, preferably less than 1.4.

The membrane is made preferably of a material which includes an amorphous fluoropolymer.

According to a further preferred embodiment, the membrane has a thickness of no more than 10 μm, preferably no more than 5 μm, and with even higher preference no more than 3 μm. The membrane can also have a thickness of less than 1 μm.

According to a further preferred embodiment, the membrane is at least in parts irradiated with high-energy ions. This measure allows, if necessary, a further thinning-down of the membrane and reduction of its optical influence in the light path of the imaging system.

According to a further preferred embodiment, the membrane is held in a fixed position by a holding device to which a holding force can be applied. The holding device can have a substantially frame-shaped holder part which is arranged on the side of the membrane that faces towards the image plane.

According to a further preferred embodiment, the holder part holds the membrane in a fixed position by way of a magnetic force.

According to a further preferred embodiment, the holding force on the membrane can be applied selectively to the holding device, so that the membrane is fixedly secured in a working position and is released in a transport position.

According to a further preferred embodiment, the inventive concept includes a control device whereby the selective application of the holding force to the holding device is controlled as a function of whether the projection objective is in an exposure-taking operating state.

According to a further preferred embodiment a tensioning device is provided, serving to apply a tensioning force to the membrane. The tensioning device can have a first and a second roller arranged rotatably on opposite sides of the projection objective and serving, respectively, to wind up and to unwind the membrane. The rollers can be actuated to feed a new section of the membrane into the interstitial space.

With this configuration it is possible to release the fixation of the membrane, e.g. between two consecutive exposures in order to allow the membrane to be advanced and a new section of the membrane to be delivered into the space between the image plane and the exit plane of the projection objective if after a large number of exposures (typically several hundred to several thousand) the transmissivity of the membrane deteriorates and the degree of scattering increases because of radiation damage.

Preferably, the rollers are controlled in a way that is dependent on an exposure activity of the projection objective and/or on whether the holding force is being applied to the holding device.

According to a further preferred embodiment, the projection objective has a compensation for an optical path-length change caused by the membrane between the object plane and the image plane.

The imaging system is designed preferably for a wavelength of 248 nm, with higher preference for 193 nm, and with an even higher preference for 157 nm.

According to a further preferred embodiment, an immersion liquid delivery system is provided which serves to fill a space between the last optical element towards the image plane and the image plane with immersion liquid. In combination with an immersion system the configuration according to the invention has in particular the advantage that it prevents an unwanted change of the exterior optical surface of the last optical element, in particular by a possible release of substance from the light-sensitive coating. Furthermore, it also provides the possibility to protect for example metal parts of the lens mount of the last optical element as well as possibly other materials in the objective (e.g., solder material) from the immersion liquid which could be an aggressive substance.

According to a further preferred embodiment, the interstitial space between the membrane and the last optical element on the side of the image plane can be filled with a liquid which does not chemically react in any substantial way with the material of the last optical element on the side of the image plane. The liquid can in particular be doped, with preference substantially to the saturation point, with ions that are present in the material of which the last optical element on the image-plane side is made, for example CaF₂ ions.

A configuration of this kind has the further advantage that for example with the use of high-purity de-ionized water as immersion liquid, it is also possible to prevent damage that this could cause to the exterior optical surface, for example by ions (e.g., CaF₂ ions) being dissolved out the last optical element on the image-plane side.

According to a further aspect of the invention, an imaging system of a microlithographic projection exposure apparatus includes a projection objective to project an image of a mask that can be set in position in an object plane onto a light-sensitive coating that can be set in position in an image plane, wherein an immersion liquid is arranged between the image plane and a last optical element on the image-plane side, and wherein a membrane that is substantially transparent for the operating wavelength of the projection objective is arranged between the last optical element on the image-plane side and the immersion liquid.

In this arrangement, there can be an interstitial space between the last optical element on the image-plane side and the membrane which can be filled with a liquid that has the property—as explained above—that it does substantially not enter into a chemical reaction with the material of the last optical element on the image-plane side. The membrane is in this case placed between two different liquids, i.e., on one side the actual immersion liquid between the membrane and the image plane or the wafer, and on the other side a suitably modified “gentle” liquid between the membrane and the last optical element on the image-plane side (i.e. for example water that is enriched or saturated with suitable ions such as CaF₂) which furthermore has an adequate transmissivity for the operating wavelength that is being used.

In an alternative embodiment the membrane can also at least part of the time be brought into direct contact with the light exit surface of the last optical element on the image-plane side.

The invention also relates to a microlithographic projection exposure apparatus for the manufacture of micro-structured components, a method for the microlithographic manufacture of micro-structured components, and a micro-structured component.

Further embodiments of the invention can be found in the description that follows as well as in the dependent claims.

The invention will be explained hereinafter in more detail with references to the attached drawings.

### BRIEF DESCRIPTION OF THE DRAWINGS

In the drawings:

FIG. 1 schematically illustrates the principal structure of an imaging system according to the invention in a preferred embodiment;

FIG. 2 represents a detail view of the circled area “II” in FIG. 1;

FIGS. 3-4 schematically illustrate how the invention is realized in an imaging system designed to operate with immersion, wherein FIG. 4 shows a detail view of the circled area “IV” in FIG. 3;

FIG. 5 schematically illustrates how the invention is realized in an imaging system designed to operate with immersion according to a further embodiment; and

FIG. 6 schematically illustrates the principal structure of a microlithographic projection exposure apparatus.

### DETAILED DESCRIPTION OF PREFERRED EMBODIMENTS

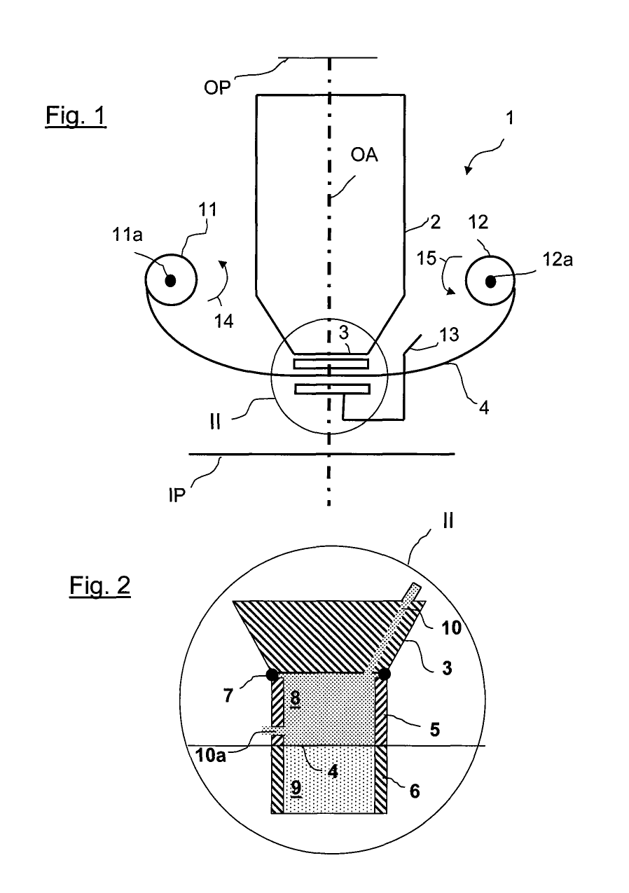

To begin with, the principal structure of a preferred embodiment of an imaging system 1 according to the invention is explained with the help of FIG. 1. The imaging system can in particular be an imaging system of a microlithographic projection exposure apparatus with a projection objective which serves to project an image of a mask (also called a reticle) which can be set in position in an object plane onto a light-sensitive coating (for example a photographic lacquer on a silicon wafer) which can be set in position in an image plane, wherein the mask structure is transferred to the light-sensitive coating of the substrate.

The invention itself is not limited to any special design of a projection exposure apparatus or of a projection objective, but can be used in a multitude of such apparatuses operating in particular with or without immersion.

Suitable imaging systems are described, e.g., in the Provisional U.S. Patent Application Ser. No. 60/544967, “Projection Objective for a Microlithographic Projection Exposure Apparatus”, filed Feb. 13, 2004, or in the Provisional U.S. Patent Application Ser. No. 60/591775, filed Jul. 27, 2004, the disclosure content of which is hereby incorporated herein by reference in its entirety.

The present invention is in particular of advantage for imaging systems that are designed for a working wavelength of 248 nm, 193 nm, or 157 nm (however without being limited to such systems). The invention can further be realized in a projection exposure apparatus in the “step-and-scan” mode as well as in the “scan-and-repeat” mode.

The imaging system 1 includes a projection objective 2 which serves to project an image of an object field which can be set in position in an object plane OP of the projection objective 2 into an image field which can be set in position in an image plane IP of the projection objective 2, wherein an optical axis OA of the projection objective 2 is shown as a dash-dotted line. In the scanning mode, the object field (for example a reticle) and the image field (for example projected on a substrate or wafer) move sideways in opposite directions relative to each other, so that a relative movement takes place in particular between the stationary projection objective 2 and the image field which in this case moves sideways at a substantially constant gap distance.

According to the invention, a membrane 4 is arranged between the image plane IP and the exit plane 3 of the projection objective 2 or, in other words, the last optical element on the image side of the projection objective 2. The material of which the membrane 4 is made and its thickness are such that the membrane 4 is substantially transparent for the operating wavelength of the projection objective 2. The expression “substantially transparent” in the context of the present invention means that the membrane 4 has a transmissivity of at least 75%, preferably at least 85%, and with even higher preference at least 95% for light of the operating wavelength of the projection objective 2.

In addition or as an alternative to being arranged between the last optical element and the image plane, a membrane according to the invention can be arranged in an analogous way between the object plane and the first optical element on the side of the object plane of the projection objective, in order to protect this exterior surface of the projection objective in an analogous way against the ambient atmosphere.

The membrane is configured preferably in such a way that its optical influence is small and/or easy to compensate. A relatively simple compensation is possible for example in the case where the membrane causes only a focusing error, as will be explained below in more detail.

The optical influence of the membrane 4 is considered to be small if a change caused by the membrane in the optical path length PD between the object plane and the image plane is small. The optical path length difference OPD due to the presence of the membrane in the light path of the projection objective is
OPD=n×d (1),

Wherein n represents the refractive index of the membrane material and d represents the thickness of the membrane.

To keep the optical influence of the membrane small or at least easy to compensate, the latter can have a thickness of, e.g., not more than 10 μm, preferably not more than 5 μm, and with even higher preference not more than 3 μm. The thickness of the membrane can also be less than 1 μm. Suitable realizations of the membrane 4 include in particular materials of the type that are known in the field as so-called pellicles, of the type that are used to protect the mask from contamination. Particularly suitable are for example amorphous fluoro-polymers with indices of refraction of n<1.41 and an absorptivity of for example less than 10% in the range of wavelengths from 190 to 820 nm, which are available for example from DuPont Photomasks, Inc., Texas.

The selection of the distance between the membrane 4 and the exit plane 3 of the projection objective 2 is substantially arbitrary and can in particular be about 1 to 2 mm (with a typical total distance of 6 to 10 mm from the exit plane 3 of the projection objective 2 to the image plane IP). The invention is however not limited to these dimensions, and the distance can also have other suitable values depending on the particular implementation.

A detailed schematic illustration of the area II of FIG. 1 is shown in FIG. 2. As shown here, the membrane 4 in this embodiment is fixated between two holder parts 5 and 6, whose arrangement in FIG. 1 is indicated only in a schematic manner and which can be made for example of magnet steel or any other suitable magnetic material. According to FIG. 2 the membrane 4 is clamped between the holder parts 5 and 6 by virtue of the magnetic attraction between them, thus effecting a fixed hold on the membrane 4, with the latter preferably being under tension in the area between the holder parts 5 and 6, as will be explained in more detail below. In order to ensure a tight contact with the membrane 4, the holder parts 5 and 6 can also be equipped with a seal (not shown here) in the contact area, for example with an elastic 0-ring on each of the parts 5 and 6.

The holder part 5 towards the projection objective 2 can for example be a flange or a mount of the last element on the image-plane side, or it can also be an additional holder part that is attached to the projection objective 2 and suitably secured on the projection objective 2 (for example through a flange connection, or attached to a mount of the last optical element on the image-plane side, or also integrally formed as a part of the projection objective 2 or of the mount of the last optical element on the image-plane side) and which can for example be sealed by way of a ring seal 7 in the area of the exit plane 3.

The invention is also not limited in regard to the materials used or the geometry of the holder parts 5, 6 which in the illustrated embodiment have a ring-shaped geometry but can also have any other geometrical configuration, with preference substantially in the form of a frame (e.g. of rectangular shape), in order to allow light to pass through the holder parts 5 and 6 along the optical path of the imaging system 1.

According to the invention, there are a broad variety of further possibilities to secure the membrane 4, wherein the latter can preferably be configured as illustrated, e.g., in FIG. 2 and designed in such a way that a gap or interstitial space 8 is formed between the membrane 4 and the last optical element on the side of the image plane, allowing the controlled introduction of a liquid or gaseous medium into the interstitial space 8 as will be explained below in more detail. The membrane is secured preferably in a way that does not interfere with the relative movement between the last optical element and the image field (for example the light-sensitive coating) which occurs during a scanning process for example in the exposure of a wafer. However, as an alternative, the invention can also be realized in such a way that the functions of securing the membrane on the one hand and forming the interstitial space 8 on the other hand (which according to this embodiment are achieved through the holder element 5) are uncoupled from each other (for example by realizing them through separate elements) insofar as for example a substantially sleeve-shaped or tubular-shaped element can serve to form the interstitial space 8, and a further holder device, clamping device, suction device, etc., can serve to hold the membrane securely in place.

Thus, the fixation of the membrane 4 below the projection objective 2, i.e., in the area between the image plane IP and the last optical element on the side of the image plane, by means of magnetic holder parts represents only one example. Alternatively, any other holder device for the fixation of the membrane 4 may be used. The membrane can for example be secured in place by means of a vacuum suction device which can for example be integrated in a suitably designed and arranged holder ring.

As can be seen in FIG. 2, an interstitial space 8 is formed between the last optical element on the image-plane side and the membrane 4, wherein a defined atmosphere can be established in the space 8 and the latter is otherwise substantially sealed off from the ambient atmosphere of the projection objective. This is achieved preferably by arranging between the last optical element on the image-plane side and the membrane 4 a substantially tubular-shaped element (in this case the holder element 5) which surrounds and forms a wall for the interstitial space 8.

The interstitial space 8 is in particular isolated by the membrane 4 in an air-tight manner from the area 9 that lies on the opposite side of the membrane 4. This arrangement is an effective way of preventing the exterior surface of the last optical element on the image-plane side of the projection objective 2 from getting into contact with the ambient atmosphere and to avert the risk of contamination of this exterior optical surface by the formation of salt or other deposits. According to FIG. 2, the interstitial space 8 can be connected to a purge circuit (not shown here) of the projection objective 2 by way of a purge channel running through the interior of the projection objective 2 (with an inlet 10 and an outlet 10a, which are preferably configured so that they can be shut off), so that the interstitial space 8 can be filled and flushed with an appropriate inert purge gas (for example nitrogen) by way of this purge channel, or the interstitial space 8 can also be connected to another suitable purge device. The interstitial space 8 can be supplied with the purge medium for example in such a way that the space 8 is first filled with the medium through the inlet 10 (while the outlet 10a is closed), or there could also be a dynamic circulation of purge gas through the inlet 10 and outlet 10a, whereby the medium in the interstitial space would be continuously renewed.

The fixation of the membrane 4 according to the invention can be controlled preferably by way of any suitable mechanism 13 in order to selectively apply the holding force to the membrane 4. This can take place, e.g., by an appropriate control of a suction device for the membrane; or a clamping element which may be arranged on the side of the image plane IP, e.g. the holder part 6 in the illustrated embodiment, can be moved relative to the holder part 5 by means of a suitable mechanism 13 in order to selectively apply the holding force. This allows the fixation of the membrane 4 to be released, for example between two consecutive exposures, in order to allow a new section of the membrane to be advanced into the space between the exit plane 3 of the projection objective and the image plane IP. This measure is appropriate if after a large number of exposures (typically a few hundred to a few thousand exposures) the transmissivity of the membrane deteriorates because of radiation damage and the amount of scattered light increases (typically by a factor of about 2 to 4).

As can be seen in FIG. 1 in an embodiment which represents only an example and does not imply any limitations, the membrane 4 can be directed from a first rotatably mounted roller 11 through the space between the last optical element on the image-plane side and the image plane IP to a second rotatably mounted roller 12, wherein the membrane 4 can be wound on the rollers 11 and 12 in particular in such a way that when the rollers 11 and 12 turn about their respective axes 11a and 12a, the membrane 4 is unwound from the one roller 11 and wound up on the other roller 12, as indicated by the arrows 14, 15 in FIG. 1. Of course, the direction indicated by the arrows 14, 15 can also be reversed.

In the foregoing manner, the membrane 4 can be fixedly secured in a working position (preferably under tension) and released in a transport position, so that by a partial unwinding and winding-up of the membrane 4 on the rollers 11 and 12, respectively, a new section of the membrane 4 can be advanced into the interstitial space between the image plane IP and the last optical element on the image-plane side when this is desired. The first and second rollers 11, 12 further allow a tension force to be applied to the membrane 4, so that the latter (after a temporary release of the fixation that is formed, e.g., by the holder elements 5, 6) can be put under tension between the last optical element on the image-plane side and the image plane IP. Any alternative holder- or tensioning device that is suitable for the purpose (with or without rollers) can likewise be used.

The projection objective can be designed preferably in such a way that a change in the optical path length that is caused by the membrane 4 in the light path between the object plane and the image plane is compensated, i.e., anticipated in the optical design, so that overall the object field is projected by the imaging system 1 into an image field with the best possible planarity and freedom from aberrations. This can be accomplished in a way which is in principle familiar to professionals in the field through an appropriate selection of the optical components (in particular lenses, mirrors and prisms) of the projection objective and the available free parameters (in particular relative distances, apex curvature radii, refractive indices, aspheres if applicable, etc.).

As the inventors have found by making measurements, the modification which the membrane 4 according to the invention causes in the image field produced by the imaging system is substantially a “focus error” which is comparatively easy to correct.

In other words, the modification which the membrane 4 according to the invention causes in the image field produced by the imaging system can be taken into account either at the outset (by making an allowance in the optical design, wherein the membrane is treated like an additional optical element) or after the fact (by correcting or compensating the focus error).

According to a further embodiment of the invention, the imaging system is designed to operate with immersion, i.e., an immersion-liquid supply system is provided to fill the space between the last optical element on the image-plane side and the image plane IP with an immersion liquid that has a refractive index larger than 1. The invention is not limited to any special immersion liquid and can consist for example of de-ionized water, an oil, or naphthalene.

Immersion liquid which escapes in the relative movement described above between the stationary projection objective and the image field (for example the light-sensitive coating on a substrate or wafer) during the scanning process is suctioned off in a conventional way by means of a vacuum nozzle and continuously replenished by way of a liquid inlet (which is connected to a liquid reservoir as well as a pumping device).

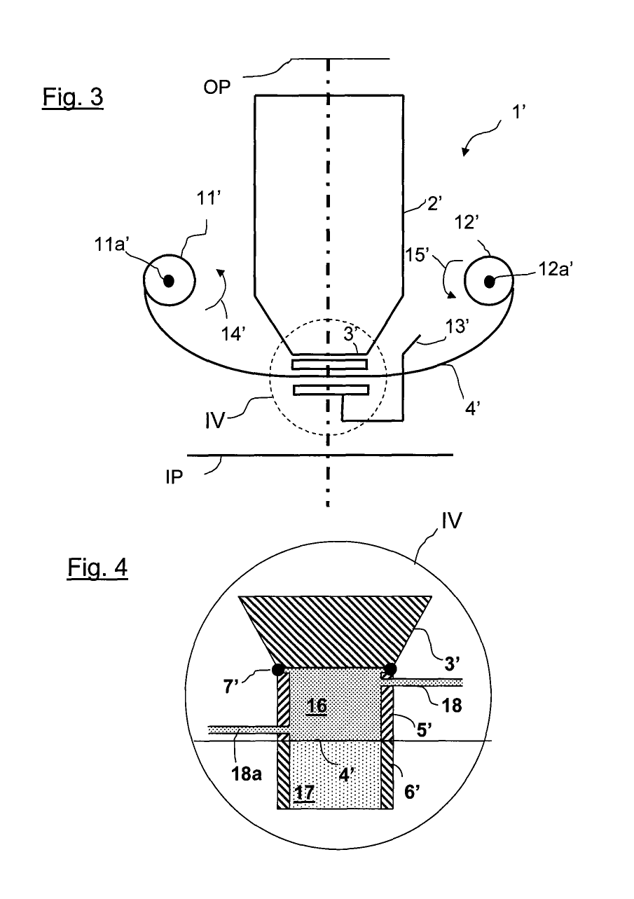

A schematic representation analogous to FIGS. 1 and 2 is shown in FIGS. 3 and 4, wherein elements performing the same function are identified by the same numbers with a prime mark added. The representation is different only insofar as in an immersion objective 2′ according to FIG. 4 an interstitial space 16 between the last optical element on the image-plane side and the membrane 4′ can be supplied or filled through a purge channel (for example with an inlet 18 and an outlet 18a according to FIG. 4, wherein the inlet and the outlet are preferably configured so that they can be closed off) with a liquid which substantially does not enter into a chemical reaction with the material of the last optical element on the image-plane side. The space 17 on the opposite side of the membrane 4′ is occupied by the immersion liquid so that, except for the slightly reduced design space as a result of adding the membrane, the design structure of the immersion objective is otherwise the same as in a conventional immersion objective, and consequently the additional apparatus for delivering and for suctioning-off the immersion liquid does not need to be described here.

If the last optical element on the image-plane side is for example a CaF₂ lens, the liquid in the interstitial space 16 between the last lens and the membrane 4′ is preferably water that has been enriched or saturated with CaF₂ ions. This has the advantage that substantially no CaF₂ ions are dissolved out of the last CaF₂ lens and consequently there is no damage to the lens as can occur for example when the lens is in contact with high-purity de-ionized water. On the other hand, due to the seal provided by the membrane 4′, the immersion liquid which occupies the space 17 on the opposite side of the membrane 4′ exit surface of the lens 20 through the air-removing suction pump 23 can be increased in steps or continuously up to the operating level (where the membrane 24 lies against the lens 20), so that after the air between the membrane 24 and the light exit surface of the lens 20 has been driven out, a tight contact of the membrane 24 is established until such time as the membrane 24 is released again by reducing the suction under the control of the suction pump 23 to allow a new membrane section to be advanced by means of the rollers 25.

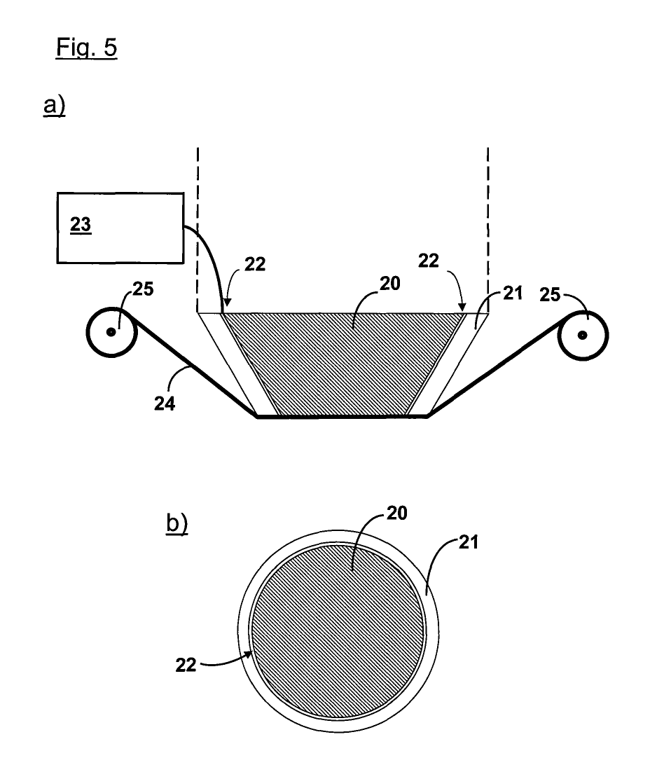

According to a further embodiment that is not illustrated and to supplement the measures described in the context of FIG. 5, the membrane 24 can also be electrically charged to improve its adhesion to the light exit surface of the lens 20. This can be accomplished for example by electrostatically charging the rollers 25 or by injecting a stream of ionized gas.

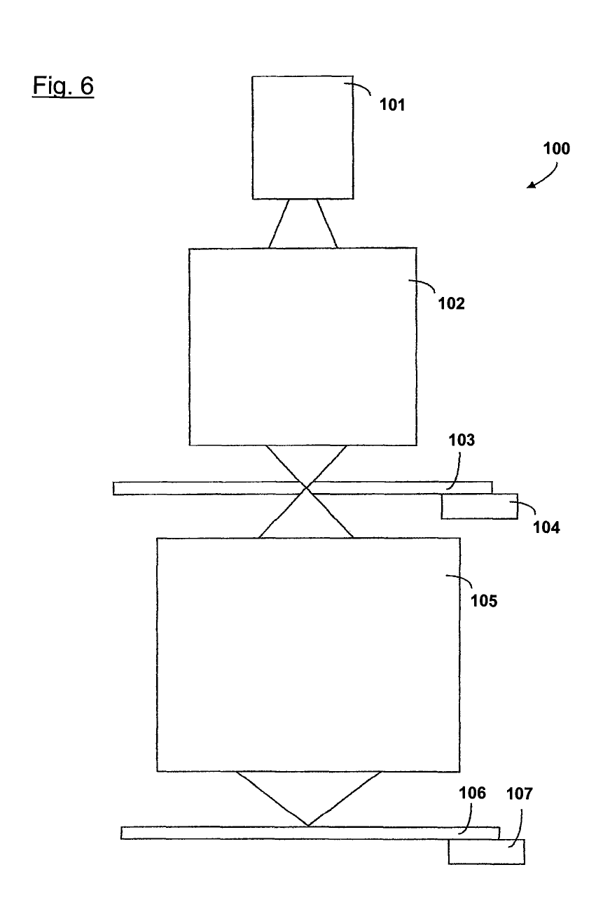

FIG. 6 schematically illustrates the principal structure of a microlithographic projection exposure apparatus with a projection objective, in which an imaging system according to the invention can be used.

According to FIG. 6, a microlithographic projection exposure apparatus 100 includes a light source 101, an illumination system 102, a mask (reticle) 103, a mask-carrier unit 104, a projection objective 105, a substrate 106 carrying light-sensitive structures or a light-sensitive coating, and a substrate-carrier unit 107. According to the invention, the position of the projection objective 105 is occupied for example by the imaging system according to FIG. 1 which includes in particular the projection objective 2 and the transparent membrane 4, or also by a projection objective designed to operate with immersion.

FIG. 6 schematically illustrates the path of two light rays which delimit a bundle of light rays from the light source 101 to the substrate 106. The image of the mask 103 which is illuminated by means of the illumination system 102 is projected by means of the projection objective 105 onto the substrate 106 (for example a silicon wafer) which carries a light-sensitive coating (photoresist) and is arranged in the image plane of the projection objective 105, whereby the mask structure is transferred to the light-sensitive coating of the substrate 106.

Albeit that the invention has been described on the basis of special embodiments, those skilled in the pertinent art will recognize numerous possibilities for variations and alternative embodiments, for example by combining and/or exchanging features of individual embodiments. Accordingly, it will be understood that such variations and alternative embodiments are considered as being included in the present invention and that the scope of the invention is limited only by the attached patent claims and their equivalents.

1. Imaging system of a microlithographic projection exposure apparatus comprising:
a projection objective that serves to project an image of a mask which can be set in position in an object plane onto a light-sensitive coating that can be set in position in an image plane; and
at least one membrane which is substantially transparent for an operating wavelength of the projection objective and which in relation to an exterior optical surface of the projection objective is arranged in such a way that between said exterior optical surface and the membrane an interstitial space is formed which is designed to receive a liquid or gaseous medium.

2. Imaging system according to claim 1, wherein said medium is substantially a chemically inert purge gas.

3. Imaging system according to claim 2, said interstitial space between the exterior optical surface and the membrane is connected to a purge circuit which serves to flush an interior space of the projection objective with said purge gas.

4. Imaging system according to claim 1, wherein the interstitial space between the exterior optical surface and the membrane is substantially sealable against the ambient atmosphere of the projection objective.

5. Imaging system according to claim 1, further including a substantially tubular-shaped element which surrounds the interstitial space and is arranged between the exterior optical surface and the membrane.

6. Imaging system according to claim 1, wherein the membrane is arranged between the image plane and a last optical element of the projection objective that is located on the image-plane side of the latter.

7. Imaging system according to claim 1, wherein the membrane is arranged between the object plane and a first optical element of the projection objective that is located on the object-plane side of the latter.

8. Imaging system according to claim 1, further including an immersion liquid delivery system which serves to fill a space between the image plane and a last optical element on the image-plane side of the projection objective with immersion liquid.

9. Imaging system according to claim 7, wherein the interstitial space between the last optical element on the image-plane side and the membrane can be filled with a liquid which substantially does not enter into a chemical reaction with the material of the last optical element on the image-plane side.

10. Imaging system according to claim 9, wherein the liquid is doped with ions that are present in the material of which the last optical element on the image-plane side is made.

11. Imaging system according to claim 10, characterized in that the ions comprise CaF₂ ions.

12. Imaging system of a microlithographic projection exposure apparatus comprising:
a projection objective that serves to project an image of a mask which can be set in position in an object plane onto a light-sensitive coating that can be set in position in an image plane;
wherein an immersion liquid is arranged between the image plane and a last optical element of the projection objective on the image-plane side of the latter; and
wherein a membrane which is substantially transparent for an operating wavelength of the projection objective is arranged between said last optical element on the image-plane side and the immersion liquid.

13. Imaging system according to claim 12, wherein the membrane is in immediate contact with a light exit surface of the last optical element on the image-plane side.

14. Imaging system according to claim 13, further including a vacuum suction device that holds the membrane in immediate contact with the light exit surface of the last optical element on the image-plane side.

15. Imaging system according to claim 12, wherein the membrane has a transmissivity of at least 75% for an operating wavelength of the projection objective.

16. Imaging system according to claim 12, wherein the membrane is made of a material which has a refractive index of less than 1.6.

17. Imaging system according to claim 12, wherein the membrane is made of a material which comprises an amorphous fluoropolymer.

18. Imaging system according to claim 12, wherein the membrane has a thickness of no more than 10 μm.

19. Imaging system according to claim 12, wherein the membrane is at least in parts irradiated with high-energy ions.

20. Imaging system according to claim 12, wherein the membrane is held in a fixed position by a holding device to which a holding force can be applied.

21. Imaging system according to claim 20, wherein the holding device comprises a substantially frame-shaped holder part which is arranged on the side of the membrane that faces towards the image plane.

22. Imaging system according to claim 21, wherein the holder part secures the membrane in a fixed position by means of a magnetic force.

23. Imaging system according to claim 20, wherein the holding force acting on the membrane can be selectively applied to the holding device, so that the membrane is fixedly secured in an operating position and released in a transport position.

24. Imaging system according to claim 20, further including a control device whereby the selective application of the holding force to the holding device is controlled dependent on an exposure-taking operating state of the projection objective.

25. Imaging system according to claim 12, further including a tensioning device serving to apply a tensioning force to the membrane.

26. Imaging system according to claim 25, wherein the tensioning device comprises a first and a second roller mounted rotatably on opposite sides of the projection objective and serving, respectively, to wind up and to unwind the membrane.

27. Imaging system according to claim 26, wherein the rollers can be actuated to advance a new section of the membrane into the interstitial space.

28. Imaging system according to claim 27, wherein said actuation of the rollers is controlled in a way that is dependent on an exposure-taking activity of the projection objective and/or on the application of the holding force to the holding device.

29. Imaging system according to claim 12, wherein the projection objective has a compensation for an optical path-length change caused by the membrane between the object plane and the image plane.

30. Imaging system according to claim 12, wherein the imaging system is designed for a wavelength of 248 nm.

31. Microlithographic projection exposure apparatus for the manufacture of micro-structured components, comprising an imaging system according to claim 1.

32. Method for the microlithographic manufacture of micro-structured components, comprising the steps of:
providing a substrate carrying at least in part a coating of a light-sensitive material;
providing a mask comprising structures of which an image is to be projected;
providing a projection exposure apparatus with an imaging system according to claim 1; and
projecting at least a part of the mask onto an area of the coating by means of the projection exposure apparatus.

33. Method for the microlithographic manufacture of micro-structured components, comprising the steps of:
providing a substrate carrying at least in part a coating of a light-sensitive material;
providing a mask comprising structures of which an image is to be projected;
providing a projection exposure apparatus with an imaging system according to claim 12, wherein an immersion liquid is arranged between the image plane and a last optical element on the image-plane side;
arranging a substantially transparent membrane between the last optical element on the image-plane side and the immersion liquid; and
projecting at least a part of the mask onto an area of the coating by means of the projection exposure apparatus.

34. Method according to claim 33, wherein the membrane is at least during part of the time brought into immediate contact with the light exit surface of the last optical element on the image-plane side.

35. Method according to claim 33, wherein the membrane is at least during part of the time electrostatically charged.

36. Method according to claim 34, wherein the process of establishing an immediate contact of the membrane with the light exit surface of the last optical element on the image-plane side, a stream of a liquid or gaseous medium is introduced on the side of the membrane that faces away from said light exit surface and said stream is directed with preference radially outward.

37. Method according to claim 32, wherein after a number of projection steps have been performed, a new section of the membrane is advanced into the area bordering on an exterior optical surface or the space between the last optical element on the image-plane side and the immersion liquid.

38. Micro-structured component made with a method according to claim 32.
